(19) United States
(12) Patent Application Publication
(10) Pub. No.: US 2019/0072996 A1
(43) Pub. Date: Mar. 7, 2019

(54) MOBILE DEVICE POP-UP SHADE

(71) Applicant: LRT ROYAL INNOVATIONS, LLC, Cincinnati, OH (US)

(72) Inventor: JULIE PICKENS, CINCINNATI, OH (US)

(21) Appl. No.: 16/121,233

(22) Filed: Sep. 4, 2018

Related U.S. Application Data
(60) Provisional application No. 62/554,180, filed on Sep. 5, 2017.
(60) Provisional application No. 62/638,723, filed on Mar. 5, 2018.

(51) Int. Cl. G06F 1/16

(52) U.S. Cl. CPC G06F 1/1603; H04M 1/04; G06F 1/1607

(57) ABSTRACT

A shade has an attachment that allows the shade to be attached to a device, a body, the body shaped to provide shade to a display screen of a device when in a shade position, a stowage component attached to the body, the stowage component to allow the body to be stowed away from the display screen of the device in a stowed position, and a deployment mechanism attached to the stowage component, the deployment mechanism to allow the shade to move from a stowed position to the shade position.

### RELATED APPLICATIONS

This application is a continuation of, and claims priority to, U.S. Provisional Application No. 62/554,180, filed Sep. 5, 2017, and U.S. Provisional Application No. 62/638,723, filed Mar. 5, 2018, both of which are incorporated herein in their entirety.

### BACKGROUND

Mobile devices, including cell phones, ‘smart phones,’ or cell phones that have network capability, mobile gaming platforms, tablets, electronic readers, etc., typically have displays. The displays may have touch screen capability. Regardless, these displays have increasingly become sharper and brighter. For users, brighter displays have several advantages, unless they attempt to use the mobile device in brightly lit environments.

A solution for this problem lies in shades. Typically, these shades attach to the front face of the device and shade the display so the user can see it. Many of the currently available mobile device shades are fixed attachments that snap onto the device already formed as a shade in a visor or umbrella, as examples. Some attach to the device by a frame and the shade can move between a closed position and a position, referred to here as the deployed position, that allows the shade to work.

### BRIEF DESCRIPTION OF THE DRAWINGS

FIG. 1 shows an embodiment of a mobile device shade.

FIGS. 2-4 show an embodiment of a mobile device shade in stages of deployment.

FIGS. 5-7 show side views of an embodiment of a mobile device shade.

FIG. 8 shows an embodiment of a mobile device shade.

FIGS. 9-11 show an embodiment of a mobile device shade in stages of deployment.

FIG. 12 shows a side view of an embodiment of a mobile device shade.

FIGS. 13-18 show an embodiment of an alternative mobile device shade.

FIG. 19 shows a side view of an embodiment of a mobile device shade.

FIGS. 20-27 show perspective and top views of an embodiment of a mobile device shade having wings.

FIGS. 28-33 show side views of an embodiment of a mobile device shade having wings.

### DETAILED DESCRIPTION OF THE EMBODIMENTS

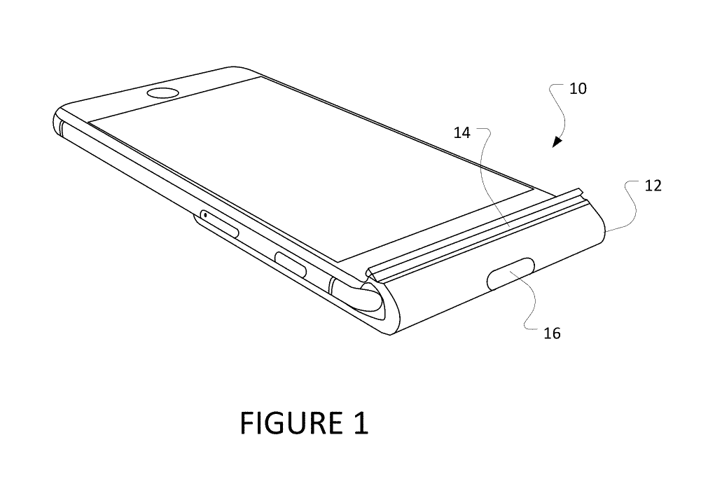

FIG. 1 shows an embodiment of a mobile device shade 10. One should note that while these embodiments discussed here relate to a shade for a mobile phone, such as a cell phone or a smart phone, but the embodiments here may apply to any mobile device. The term ‘mobile device’ as used here includes cell phones, ‘smart phones,’ which are cell phones that have network capability, mobile gaming platforms, tablets, electronic readers, etc. The embodiments of the mobile device shade here include a body, an attachment, a deployment mechanism, and a stowage component. Some embodiments may also include sides, which may be referred to as wings.

The term ‘body’ as used here generally refers to a part of the shade that provides shade to the display screen of the mobile device. The body may have at least one dimension that matches one of the dimensions of the display screen of the mobile device. For example, the shade may have the same width of the mobile device but be shorter. The shade may be larger or smaller that the display screen depending upon its angle of deployment when in use, as it may provide or not provide enough shade at different sizes.

The term ‘attachment’ as used here generally refers to any means used to attach the shade to the mobile device. This may include adhesives, clips, magnetic attachments, or just having the shade have a shape conforming shaped to the mobile device to allow it to be snapped or clipped around the periphery of the device, just as examples.

The term ‘deployment mechanism’ as used here generally refers to any mechanism that allows the shade to move from a stowed position, in which it is out of the way of the display screen and otherwise not noticeable to the user, to a deployed position in which is provides shade to the mobile device. This may include a combination of a releasable catch, such as a button, and a spring, a releasable catch and spring combined with a roller, or a hinge, just as examples.

The term ‘stowage’ component as used here generally refers to a structure, mechanism, or combination of structure and mechanism that allows the shade to be stowed out of the user's way and renders the shade essentially not noticeable to the user. In some instances the stowage component and the deployment mechanism may be the same component, or parts of the same component.

A housing 12 encloses a shade body shown in further discussion. The housing 12 snaps or otherwise attaches to the device in a manner that does not cover the display. The housing has an opening adjacent the display, and the shade body has a lip 14 that prevents the shade body from too far into the housing 12. In this embodiment the housing acts as the stowage component, and the attachment consists of a conformal shape that snaps onto the mobile device.

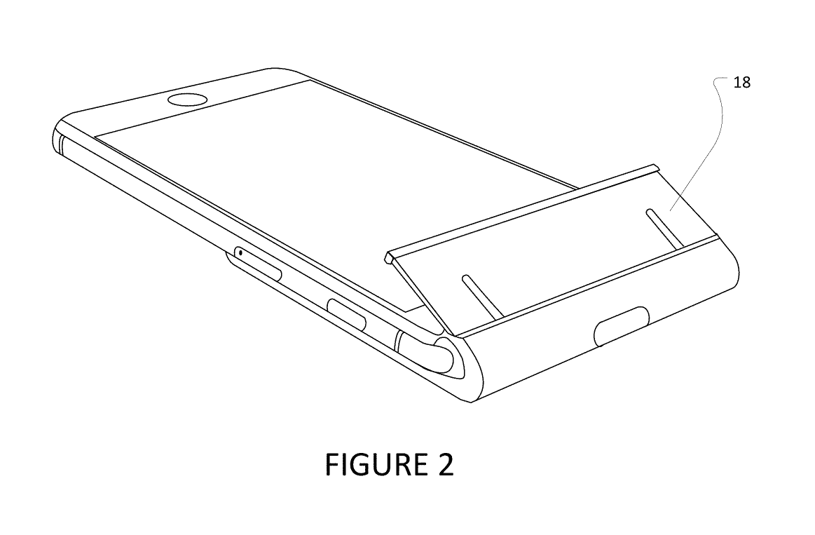

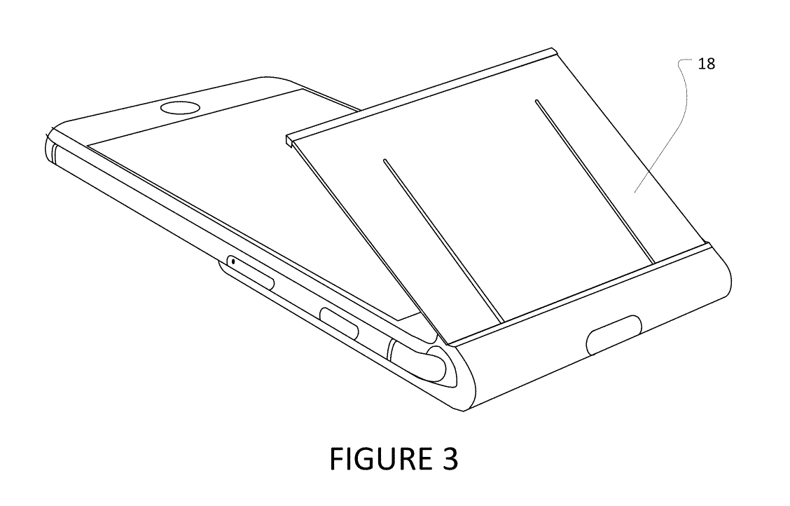

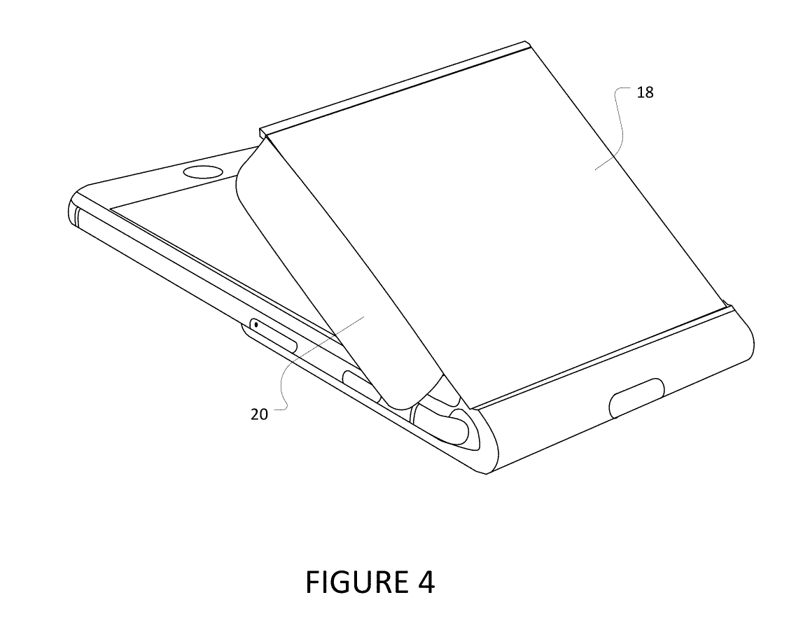

A catch 16 make keeps the shade body stowed inside the housing 12 until released. A user may press the catch 16 and that causes a spring mechanism to activate and release the shade body, acting as the deployment mechanism. As shown in FIG. 2, the shade body 18 slides out of the housing 12. FIG. 2 shows the shade body as it begins to deploy, and FIG. 3 shows it as progresses out of the housing. When going into the full deployment here, shade sides, or wings, such as 20 unfold from a position flush against the shade body 18 and provide shade to the sides of the display. Typically, the wings will unfold from a side of the body that ultimately faces the display screen of the device when deployed, but may also deploy and rotate more than 180 degrees from the side of the body away from the display screen of the device.

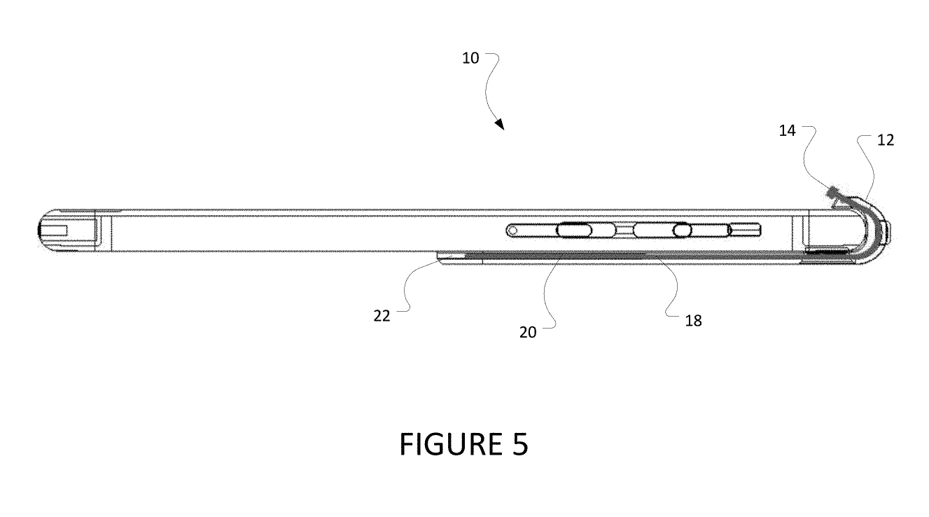

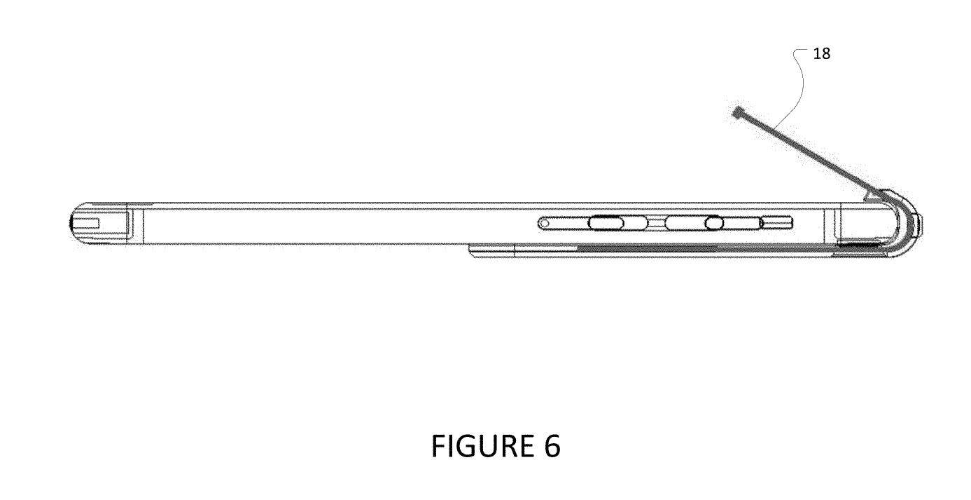

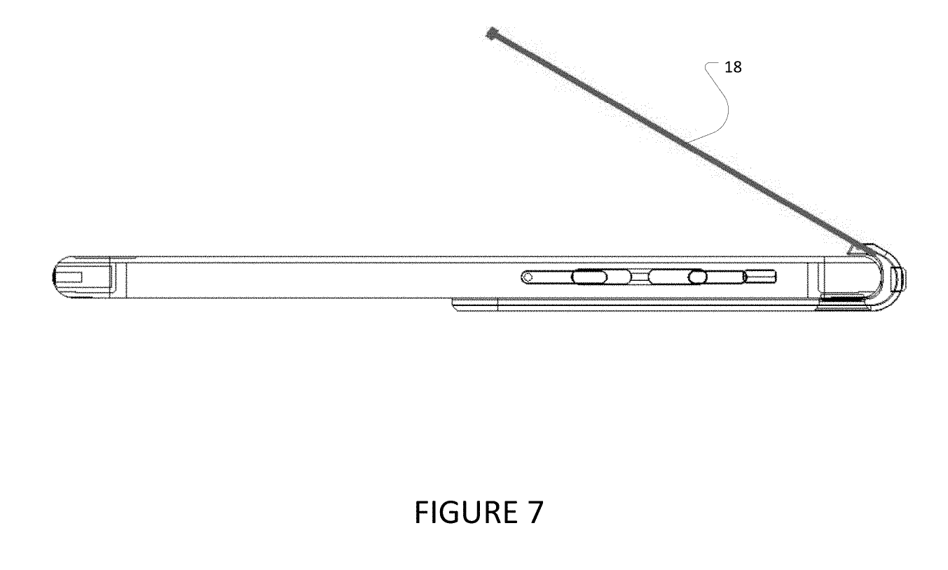

FIG. 5 shows a side view of the interior of the housing 12. The housing 12 contains a slot or chamber 22 that can contain the shade body 18 and has sufficient depth to contain the thicker portion where the sides, such as 20, fold up against the shade body 18. Also shown in FIG. 5, the lip 14 prevents the shade body from going too far into the slot 22, making it difficult for the user to deploy the shade body. FIGS. 6 and 7 show the movement of the shade body 18 as it slides out of the slot until it is fully extended. In this embodiment, the stowage component consists of a slot that lies parallel to the device display

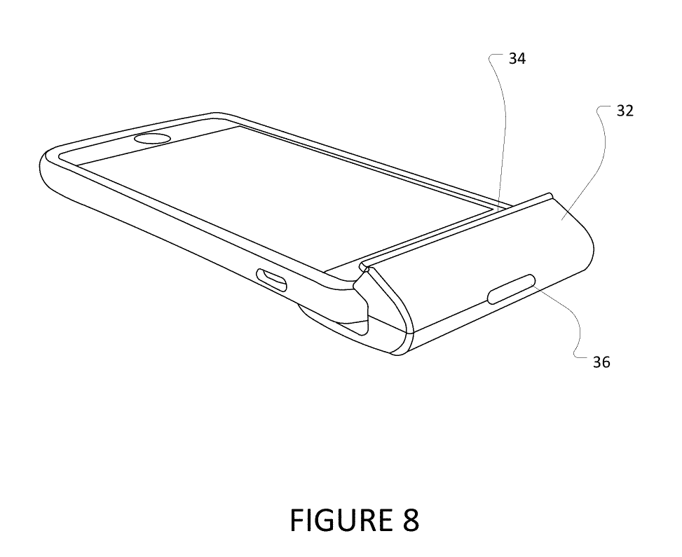

FIG. 8 shows another embodiment of a mobile device shade. The housing 32 as the stowage component may be slightly larger than the housing 12 of the other embodiment as it contains a different sliding mechanism. The embodiment of FIG. 8 also includes a lip 34 to prevent the shade body from sliding too far into the housing. In this embodiment, the catch 36 releases a spring mechanism that causes the shade body to roll and unroll like a window shade or a writing scroll, acting as a deployment mechanism in conjunction with the spring. In this embodiment, the stowage component consists of a chamber at the end of the device.

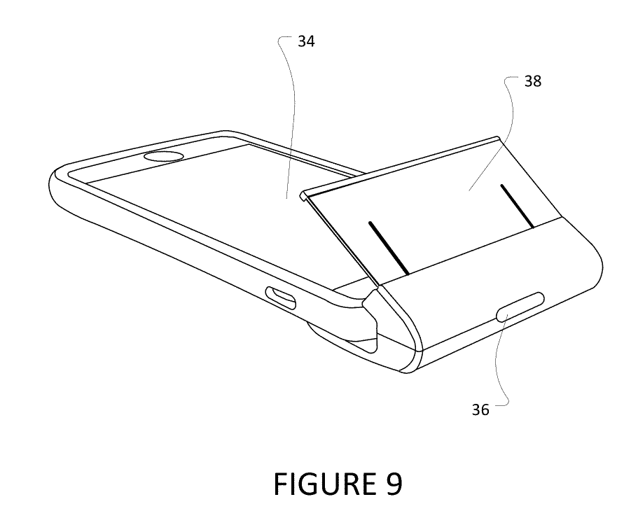

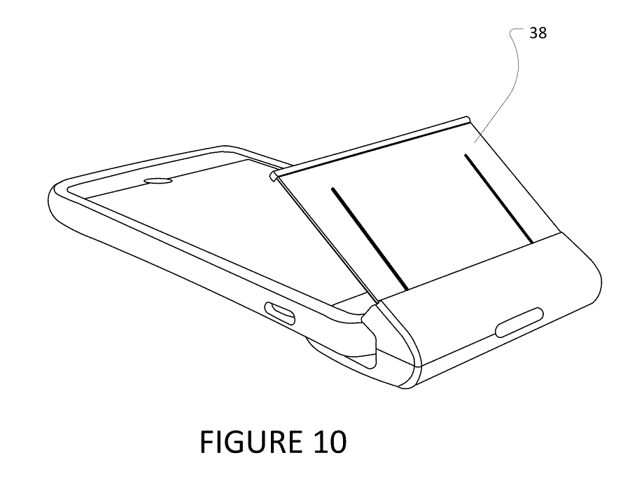

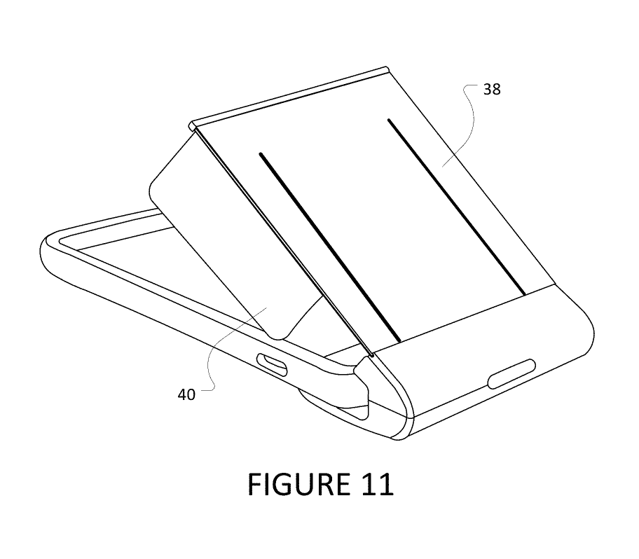

FIGS. 9-11 show the shade body 38 as it deploys. FIG. 9 shows it in its early stage, and FIG. 10 shows the shade as it moves closer to full deployment. In FIG. 11, one can see the wings or sides 40 of the shade body 38 as it reaches full deployment.

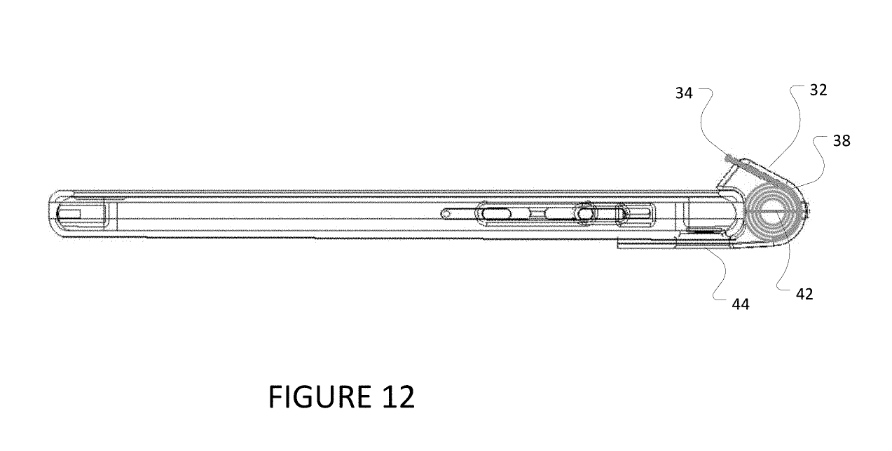

FIG. 12 shows a side view of the interior of the housing 32. As can be seen in this embodiment, the shade body 38 rolls up around the spring mechanism 42 which may take up more room than the sliding embodiment, resulting in the housing 38 of this embodiment of being larger. However, the housing may also be of the same size as the housing in the previous embodiment. The stowage component consists of the housing, the spring mechanism and release make up the deployment mechanism and the attachment may consist of an adhesive or magnet attachment between the back of the housing and the device.

One should note that in this embodiment, the shade body 38 remains at the end of the mobile device and may include an opening 44 to allow the camera, and light, of the phone to be accessible outside the housing. In the previous embodiment, the shade may have a hole in it where the camera and light reside when the shade is in the stored position such as the one shown in FIG. 5.

While some variations and modifications may be discussed above regarding specific embodiments, one should note that any variation and modification may apply to any embodiment, whether specifically discussed above or not. For example, a spring mechanism is discussed in the scrolling embodiment such as that shown in FIG. 8, may be employed in the embodiments of the rolling or sliding embodiment shown in FIG. 5.

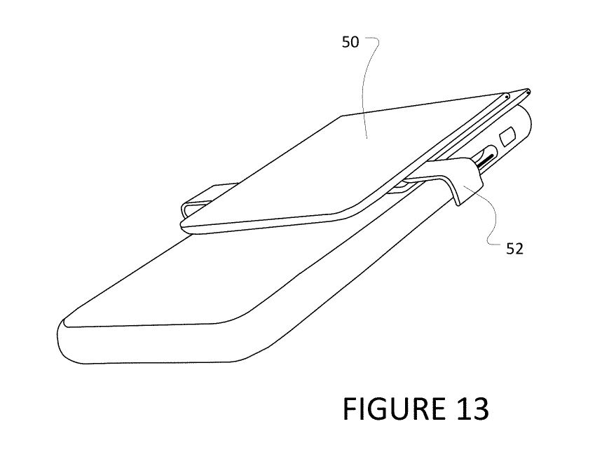

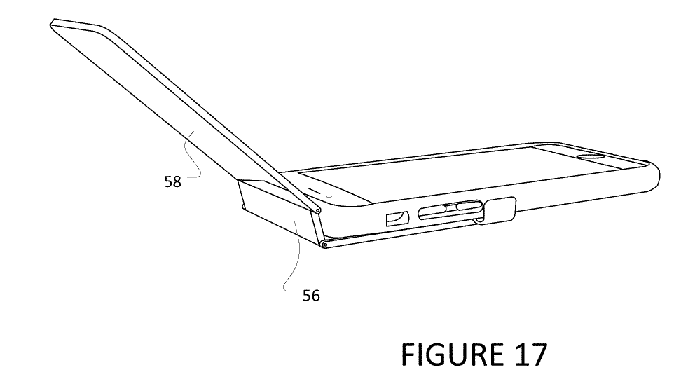

FIGS. 13-18 show an alternative embodiment of a mobile device shade. FIG. 13 shows an embodiment of a mobile device shade 50 that clips onto the back of a cell phone or mobile device with clips 52. Clips 52 may consist of a flexible plastic that allows the clips to flex and then contract around the device body to stay in place. In these embodiments, the clips make up the attachment.

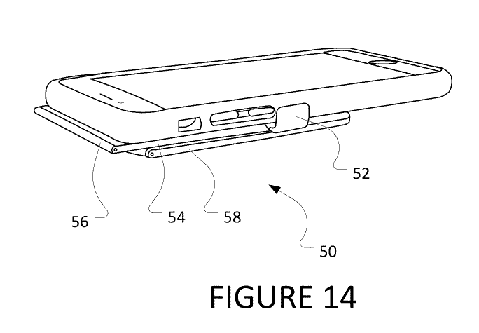

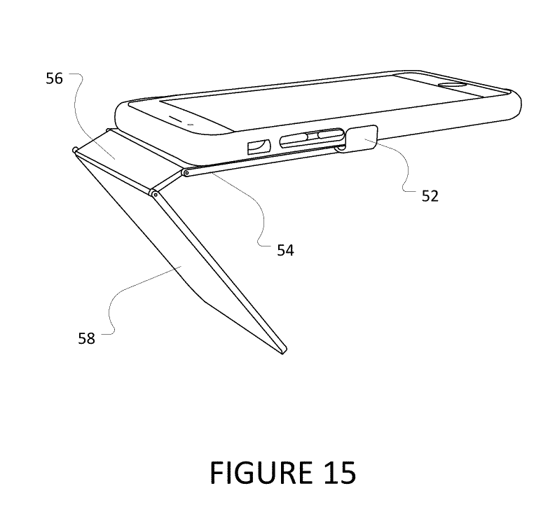

FIG. 14 shows the mobile device shade 50 in its stored configuration. The mobile device shade 50 in this embodiment consists of a back plate 54 that resides against the back of the device, a hinge portion 56, and a shade body 58. FIG. 15 shows the shade body as it moves into its deployed position. The hinge 56 has a width that allows it to match the top of the phone. In some embodiments, the hinge portion may be translucent, clear or have a hole in it to accommodate the camera and flashlight. The hinge portion will more than likely not be part of the mobile device shade to actual provide shade to the screen. The hinge in this embodiment makes up the deployment mechanism, and the back plate makes up the stowage component. The hinge may consist of two pins having holes into which they insert in the body and a center piece between the two pins.

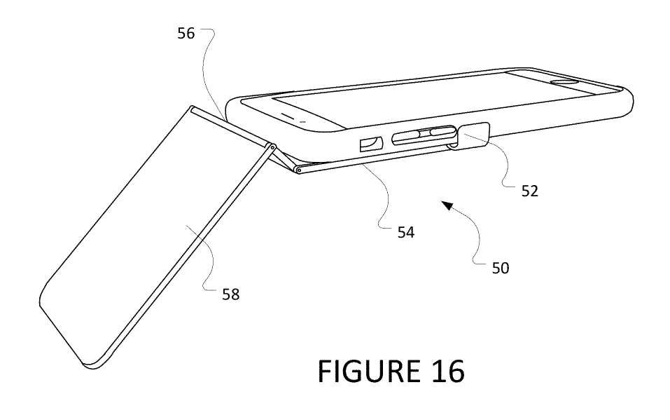

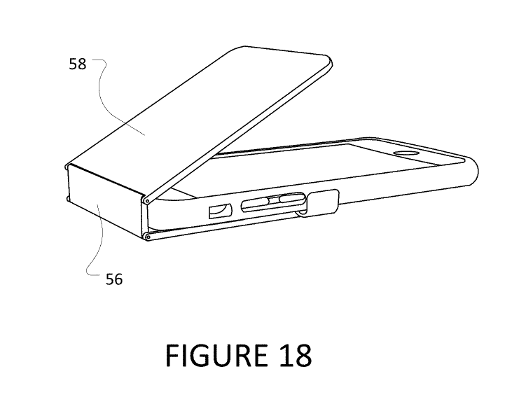

FIGS. 16-18 show the various stages of the shade body 58 and the hinge 56 as they move from the stored position to the deployed position of FIG. 18. In the embodiment shown, the shade body does not have side pieces or wings, relying only on the body to provide shade to the display screen of the mobile device. However, as stated above, the wings or side pieces may be part of any embodiment. The side pieces may fold against the shade body and then unfold to cover the sides.

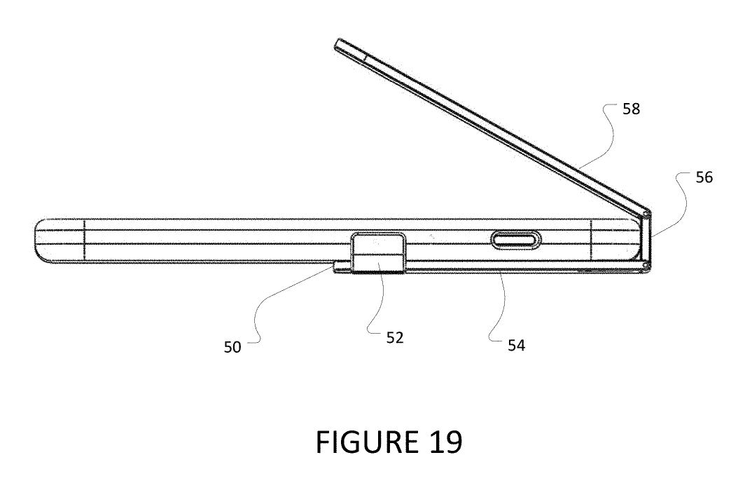

FIG. 19 shows a line drawing of a side view of the mobile device shade 50 having a hinge clipped onto the mobile device with clip 52. The back plate 54 stays in place against the back of the device. The hinge 56 meets the top of the device and the shade body 58 deploys to provide shade to the screen.

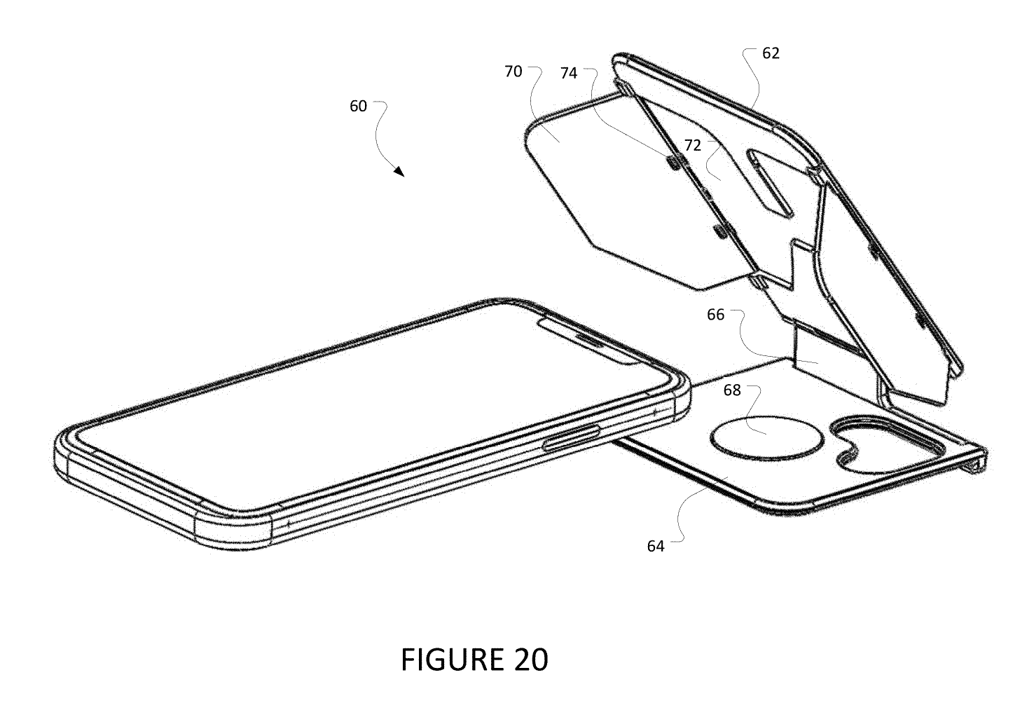

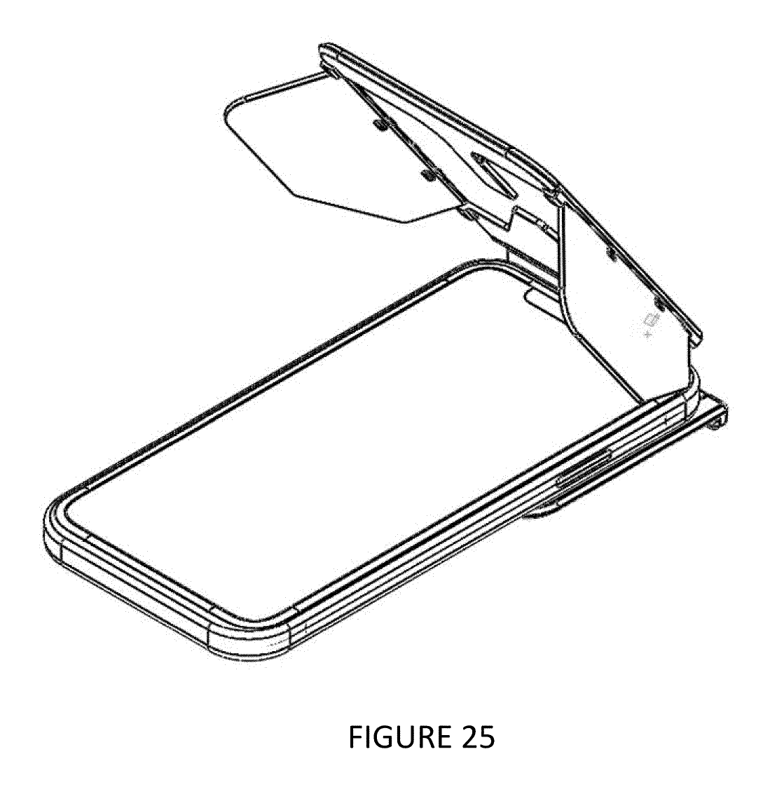

FIGS. 20-27 show perspective and top views of a mobile device shade 60 in conjunction with a mobile device. The mobile device shade has a face plate 62 as the body, a back plate 64 as the stowage component, and a hinge 66 that connects them and allows them to surround the phone, acting as the deployment mechanism. The shade 60 may attach to the phone by a magnetic or adhesive device 68. The underside, or device facing side of the body, in this orientation, has insets such as 72 in which the wings such as 70 reside. This allows the face plate to lie against the phone flat like a cover. Similarly, the attachment 68 may be inset into the back plate to allow it to lie flat against the back of the phone. The wings rotate out of their insets along the wing hinges such as 74. These hinges may consist of a hinge pin that inserts into insets in the edges of the body and the wings, a hinge external to the device that attaches to the wings and body, or a portion of the wings and body shaped to form a hinge. In an alternative embodiment, the wings may reside on the device facing side, or may reside on the opposite side of the body. In this latter case, the wings would rotate almost 180 degrees to reach their deployed position. Typically, though, they will be on the underside of the body.

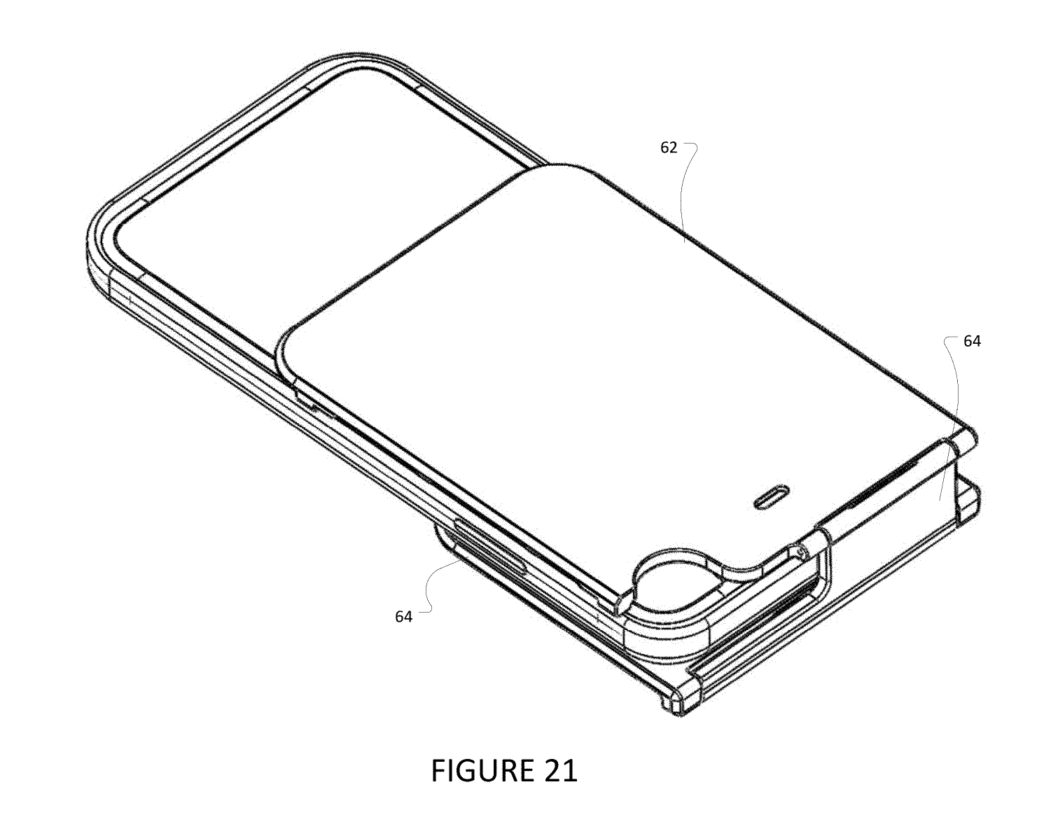

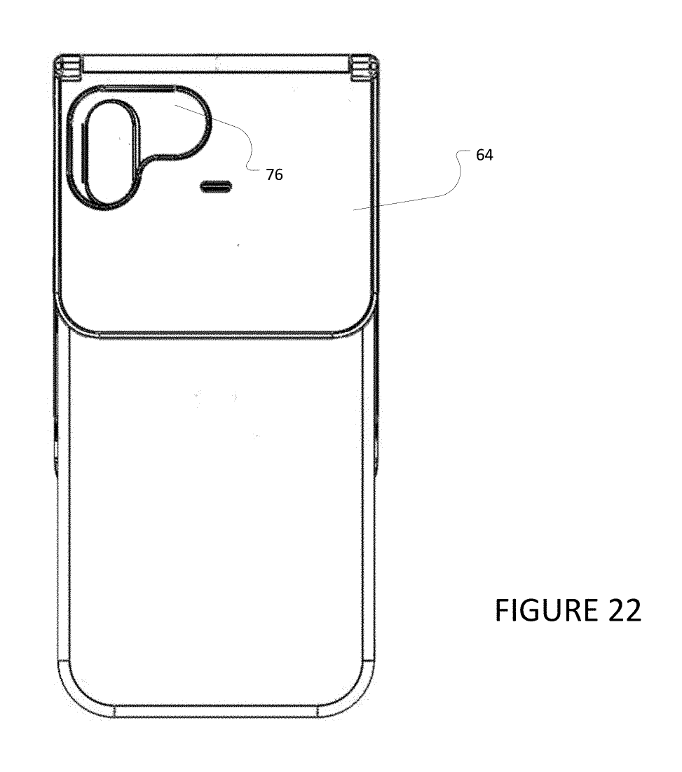

FIG. 21 shows the shade in what will be referred to here as the flat deployed position. The front plate 62 lies against the front of the phone and the back plate 64 lies against the back of the phone. The hinge 64 is sized to allow the plates to lie flat. FIG. 22 shows the back plate 64 on the phone when the shade is in the flat deployed position. The back plate has a hole 76 to allow the camera and/or flashlight to still be used when the shade is attached.

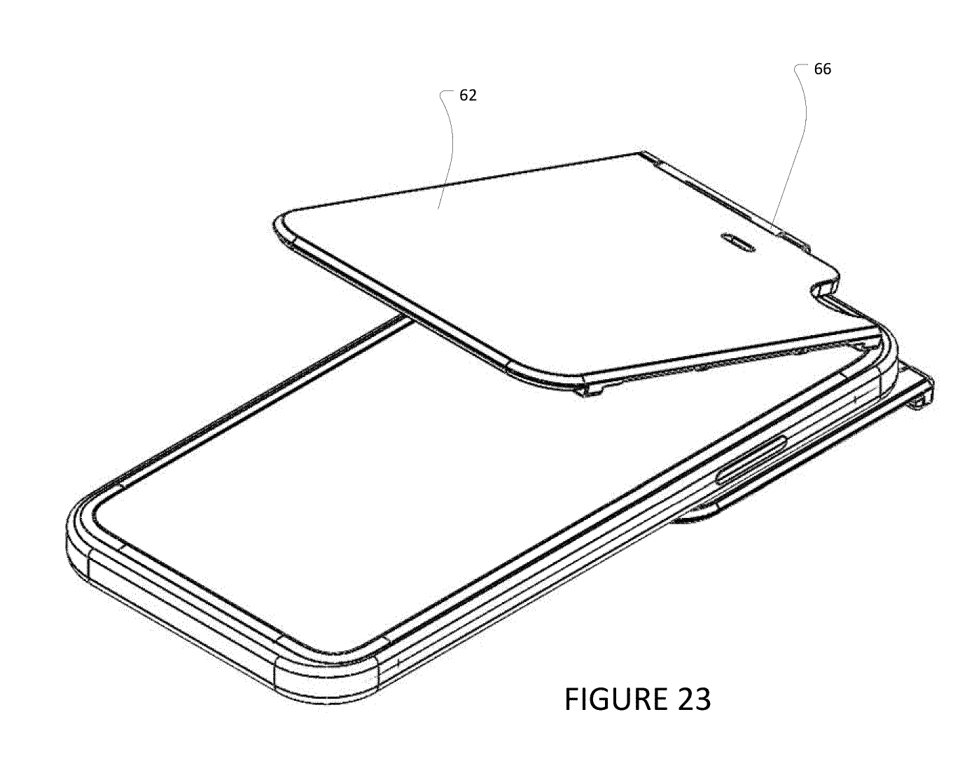

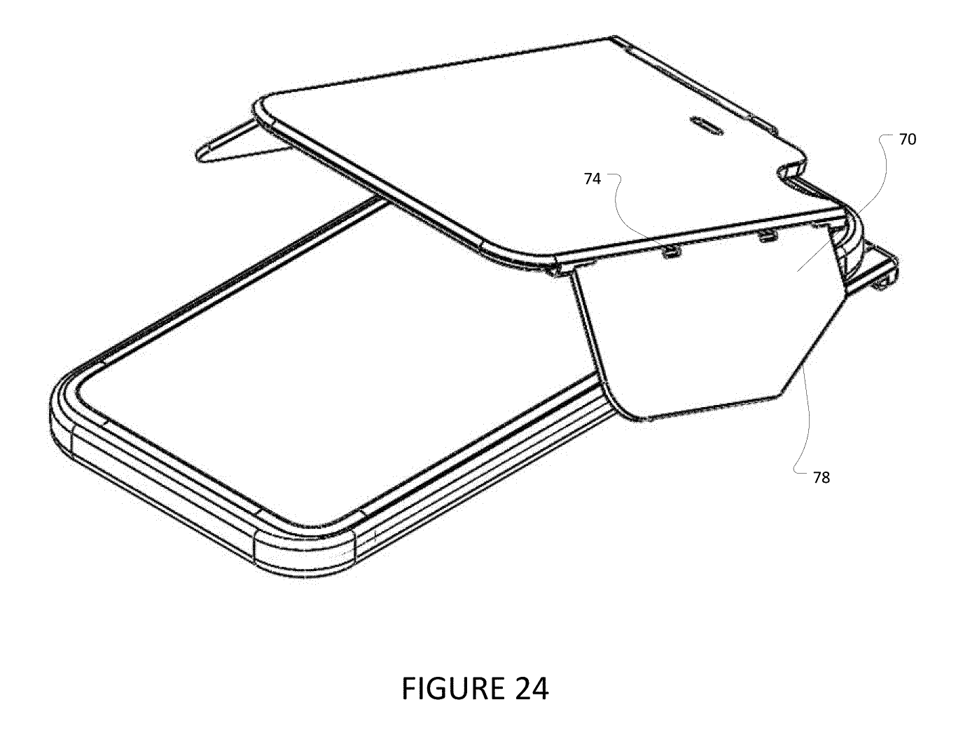

FIGS. 23-25 shows the wings as they are being deployed from under the front plate. The edges such as 78 shown in FIG. 24 of the wings may be brought to rest on the periphery of the display screen of the phone to act as both a privacy and a sun shade. The wings do not have to contact the device to work, however, the face plate can remain above the screen with the wings deployed and no contact between the edges and the device. These figures show the shade in the deployed winged position. As mentioned before, any embodiment of the shade may include wings or not have wings.

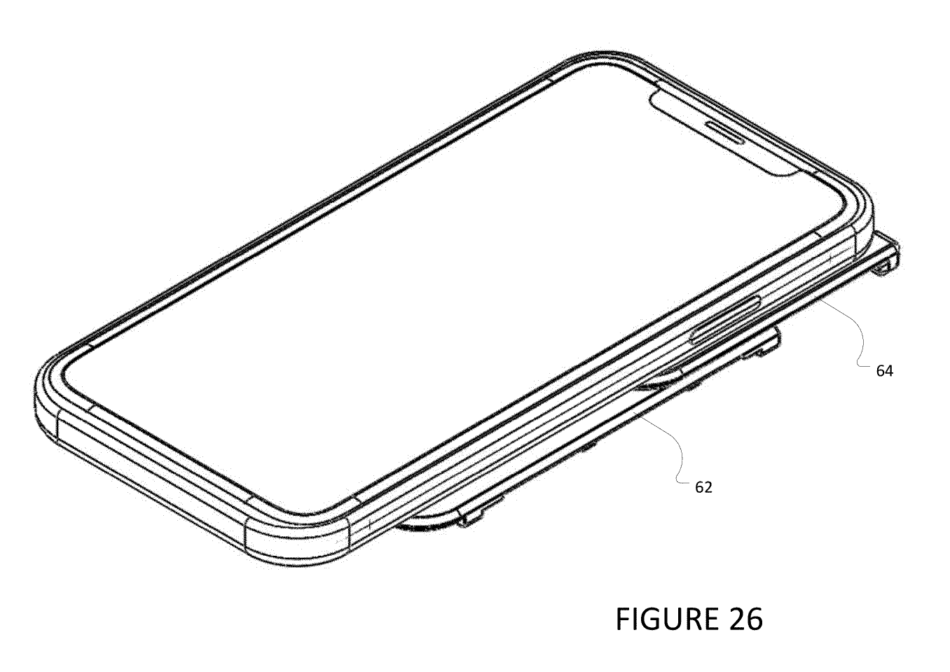

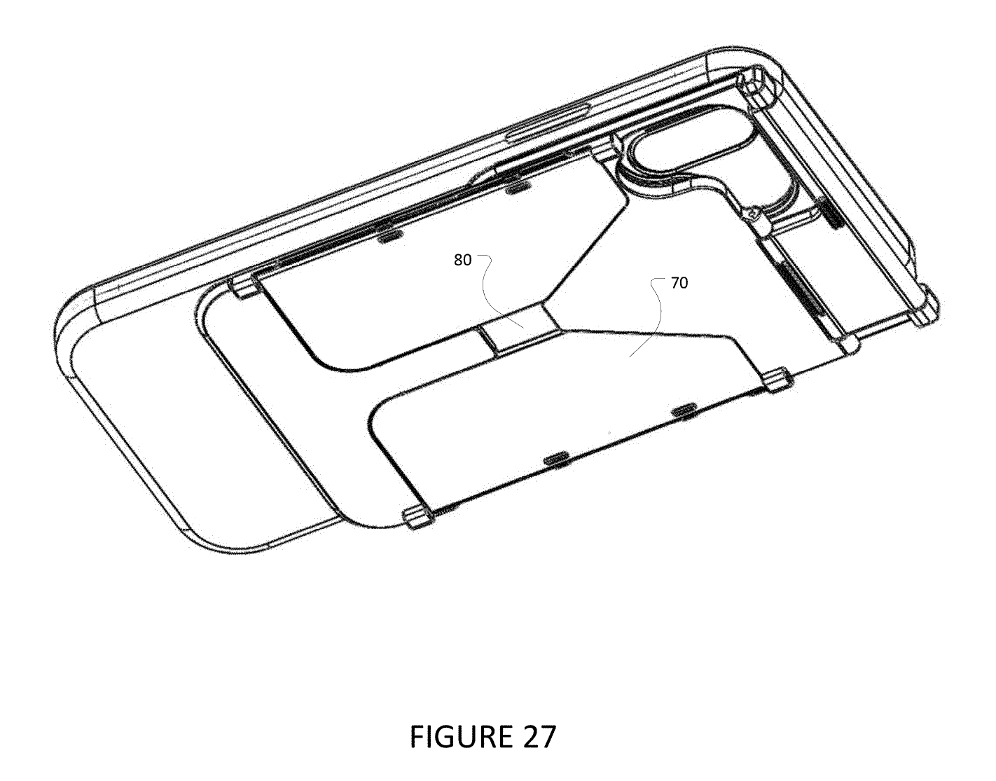

FIG. 26 shows the shade in the undeployed position, where the face plate 62 is folded up against the back plate 64 on the back of the device. FIG. 27 shows the wings such as 70, set into their insets on the front plate. There is a gap 80 between the two wings in the inset to allow the wings to be deployed.

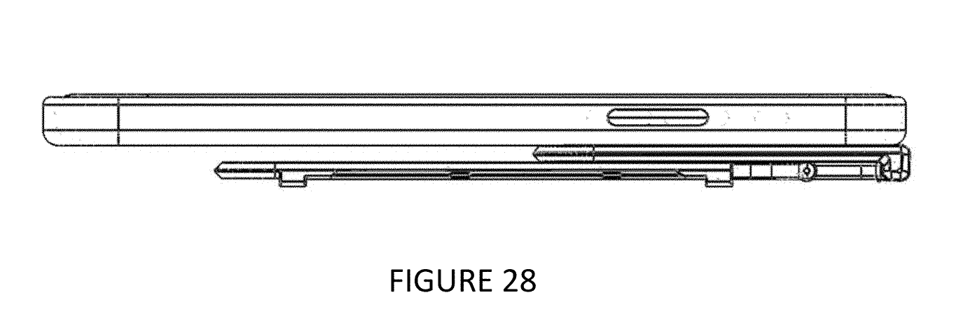

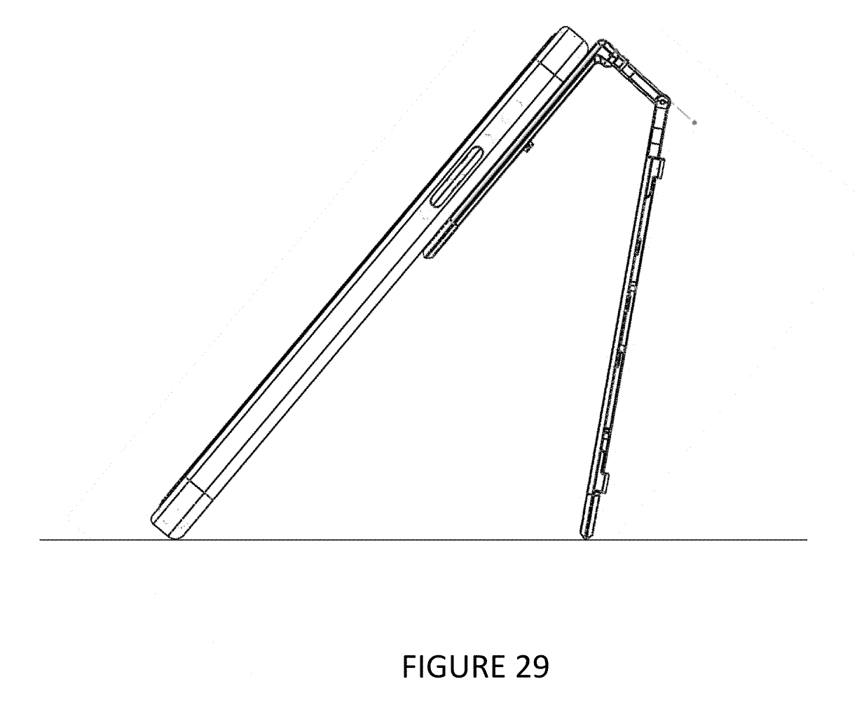

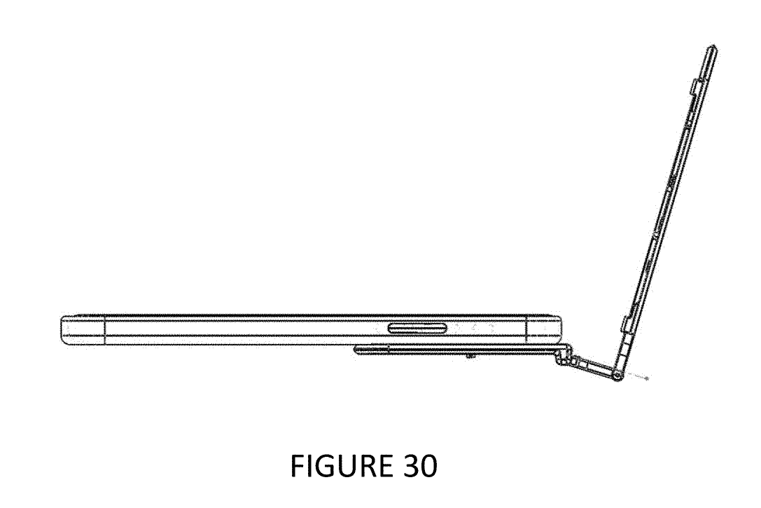

FIGS. 28-33 show side views of the mobile device shade 60 in its various configurations. FIG. 28 shows a side view of the shade in the undeployed position, with the face plate/body against the back plate on the back of the device. In this configuration the user can use his or her phone without noticing that the shade is present. FIG. 29 shows the face plate partially deployed. One should note partially deploying the face plate also allow the shade to be used as a stand, by placing the phone on a surface on its base and then tilting it back against the partially deployed screen. If one were to stand the phone on its bottom and lean it back against the shade, the shade would become a stand for the phone. FIG. 30 shows it in the flat deployed position in which the back of the phone and the back plate are flat on a surface and the face plate is moving into position over the screen.

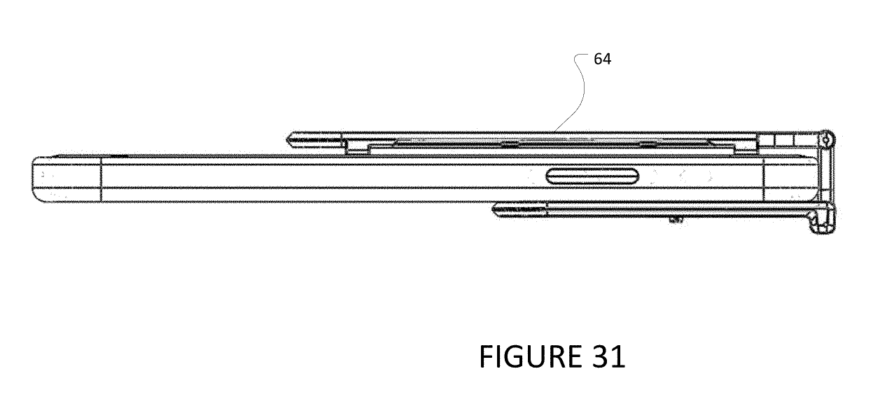

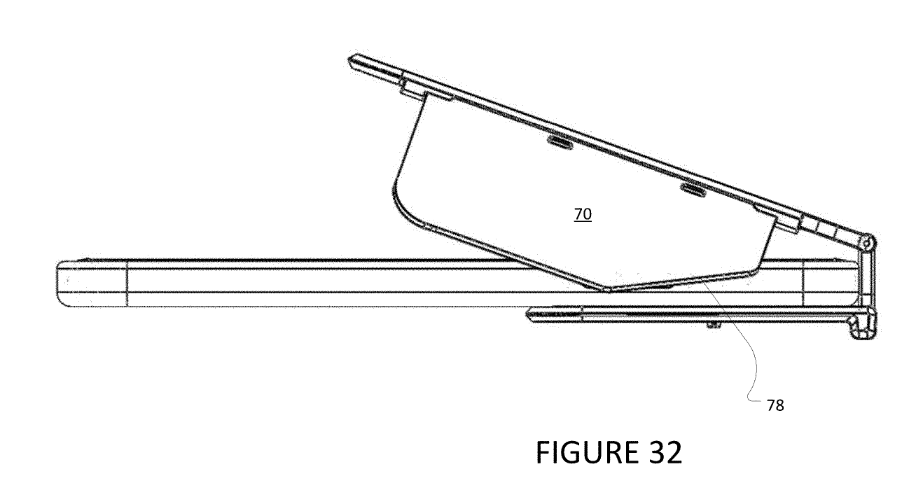

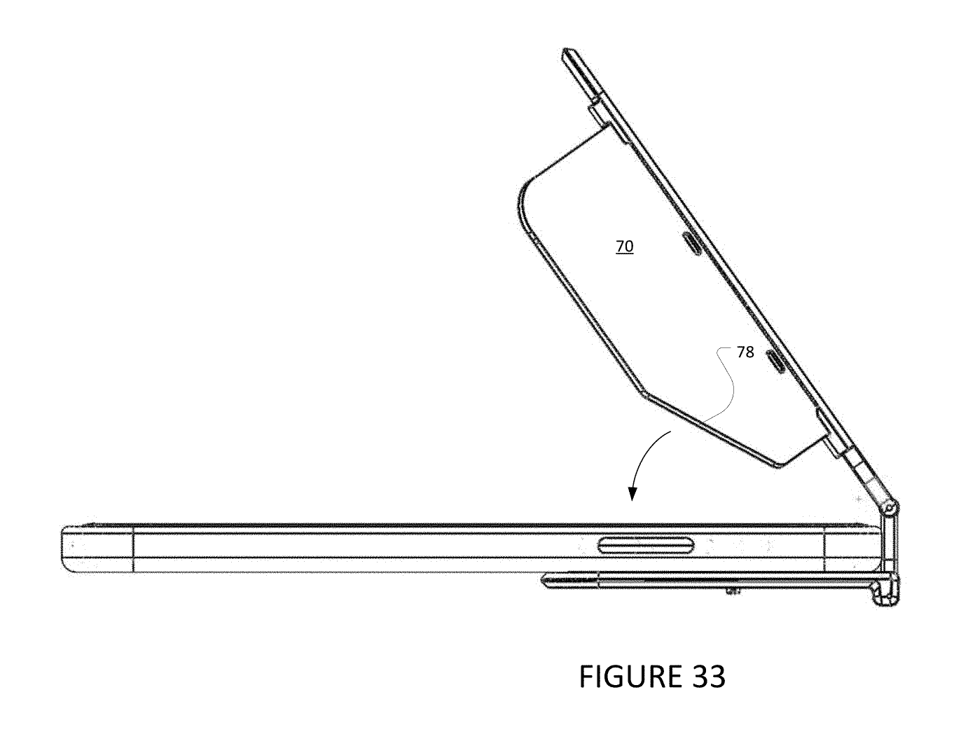

In FIG. 31, the face plate 64 has covered the display screen of the device. Some users may prefer this configuration for when they put their phones away, as it protects the front screen, rather than the configuration when the face plate is flat against the back of the phone. FIG. 32 shows the face plate as it is raised off the display screen of the phone and the wings such as 70 are deployed outwards from the face plate 64. FIG. 33 shows the shade in one of the deployed configurations. User may prefer this deployment with the face plate and the wings above the screen, as it may give a better viewing angle on the display screen. Alternatively, in a configuration not shown, the user could lower the face plate such that the edges 78 of the wings contact the device.

In this manner, relatively compact and easily deployable mobile device shades are provided. The shades store in a configuration that does not appreciably increase the thickness of the device, allowing it to conveniently slide into pockets, purses, and bags. The mobile device shade may consist of inexpensive materials such as plastic, plasticized card stock, vinyl film, etc. It allows the user to have a privacy screen, a partial block of ambient light in bright situations, or a slim, attached phone stand.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A shade, comprising:
an attachment that allows the shade to be attached to a device;
a body, the body shaped to provide shade to a display screen of a device when in a shade position;
a stowage component attached to the body, the stowage component to allow the body to be stowed away from the display screen of the device in a stowed position; and
a deployment mechanism attached to the stowage component, the deployment mechanism to allow the shade to move from a stowed position to the shade position.

2. The shade of claim 1, further comprising a set of wings extendable from the body to form side shades on either side of the body.

3. The shade of claim 2, wherein the wings each attach to the body by a wing hinge.

4. The shade of claim 2, wherein the body includes an inset for each wing, allowing the side of the body containing the wings to be flat.

5. The shade of claim 2, wherein the wings reside against a device-facing side of the body when not deployed.

6. The shade of claim 1, where in the attachment comprises one selected from the group consisting of: an adhesive, a magnetic attachment, clips, and a conformal shape.

7. The shade of claim 1, wherein the stowage component comprises one selected from the group consisting of: a housing having a slot, a housing having an end chamber, and a back plate.

8. The shade of claim 1, wherein the deployment mechanism comprises one selected from the group consisting of: a spring and a release; a spring, a release and a roller; and a hinge.

9. A shade, comprising:
an attachment that allows the shade to be attached to a device;
a body, the body shaped to provide shade to a display screen of a device when in a shade position;
a stowage component attached to the body, the stowage component to allow the body to be stowed away from the display screen of the device in a stowed position;
a deployment mechanism attached to the stowage component, the deployment mechanism to allow the shade to move from a stowed position to the shade position; and
wings extendable away from the sides of the body to form side shades.

10. The shade of claim 9, wherein the wings each attach to the body by a wing hinge.

11. The shade of claim 9, wherein the body includes an inset for each wing, allowing the side of the body containing the wings to be flat.

12. The shade of claim 9, wherein the wings reside against a device-facing side of the body when not deployed.

13. The shade of claim 9, where in the attachment comprises one selected from the group consisting of: an adhesive, a magnetic attachment, clips, and a conformal shape.

14. The shade of claim 9, wherein the stowage component comprises one selected from the group consisting of: a housing having a slot, a housing having an end chamber, and a back plate.

15. The shade of claim 9, wherein the deployment mechanism comprises one selected from the group consisting of: a spring and a release; a spring, a release and a roller; and a hinge.

16. A shade, comprising:
an attachment that allows the shade to be attached to a device;
a back plate attached to the attachment on a back side of the device;
a hinge connected to a top side of the back plate adjacent a top of the device;
a body connected to the hinge, the body movable about the hinge between a stowed position against the back plate or a deployed position adjacent a display screen of the device, wherein the body provides shade to the display screen of the device in the deployed position; and
wings extendable away from the sides of the body to form side shades.

17. The shade of claim 16, wherein the attachment comprises one selected from the group consisting of: an adhesive, a magnetic attachment, clips, and a conformal shape.

18. The shade of claim 16, wherein the wings attach to the body with wing hinges.

19. The shade of claim 16, wherein the body has an insert configured to accommodate the wings such that the side of the body containing the wings to be flat.

20. The shade of claim 16, wherein each wing has an edge shape to allow the wings to rest on the device.
